(19) United States
(12) Patent Application Publication
(10) Pub. No.: US 2013/0314522 A1
(43) Pub. Date: Nov. 28, 2013

(54) PATIENT MONITORING SYSTEM

(71) Applicants: Mordchai Ravid, Tel Aviv (IL); Itzhak Pomerantz, Kfar Saba (IL); Amnon Unger, Givatayim (IL); Eyal Katz, Ramat Gan (IL); Rony Aharon Eidlin, Netanya (IL); Tamir Eden, Raanana (IL)

(72) Inventors: Mordchai Ravid, Tel Aviv (IL); Itzhak Pomerantz, Kfar Saba (IL); Amnon Unger, Givatayim (IL); Eyal Katz, Ramat Gan (IL); Rony Aharon Eidlin, Netanya (IL); Tamir Eden, Raanana (IL)

(73) Assignee: AFEKA TEL AVIV ACADEMIC COLLEGE OF ENGINEERING, Tel Aviv (IL)

(21) Appl. No.: 13/478,769

(22) Filed: May 23, 2012

(51) Int. Cl. H04N 7/18

(52) U.S. Cl. 348/77

(57) ABSTRACT

A system implements a camera to monitor a patient and medical devices. The camera's field of view is segmented into segments having images of the patient and the medical devices, and activities represented in the segmented images are designated for which to send a notification. Images captured by the camera are analyzed according to the field of view segmentation and the activity designation so it can be determined when the designated activities have occurred. A notification is executed when a designated activity has occurred. The system, which has a relatively low-cost and is easy to install, assists health care providers in monitoring a greater number of patients with minimal effect on the patients' privacy.

### BACKGROUND

In hospitals, nurses, doctors, and other health care personnel periodically visit each patient of a large group of patients to check their well-being as they await their treatment or rest and recuperate from it. Typically, patients rest in their rooms with at least one medical device monitoring an aspect of their health. For example, an electrocardiograph (EKG) instrument may operate to measure the patient's heart rate. When a health care provider visits a particular patient, he/she checks the biometric readings of the medical devices. Additionally, the health care provider observes whether the patient appears in the expected condition, for example, whether there are convulsions or skin color changes visible that would indicate that the patient's condition is worsening.

To care for greater numbers of patients, hospitals need to hire more staff and/or find ways to enable the existing staff to care for the greater numbers. Nursing stations can be equipped with digital displays and alarms that are connected to some types of medical devices that monitor the patients, so the nurses can receive updates regarding their patients' health while they are working at a centralized location. However, monitoring those medical devices is only part of the nurses' responsibilities. Many medical devices do not have remote monitoring functionality. Also, the nurses still need to visit the patients to check for symptoms that medical devices do not check, such as changing skin color as a symptom of failing health. The patients, who may or may not be conscious, may be making audible sounds of distress. Close circuit television with or without sound can be installed in the patients' rooms, but such installations significantly increase operating costs and additionally raise concerns about privacy issues. Further, it is questionable whether a nurse at a central location can effectively monitor tens of patients simultaneously by relying heavily on close circuit television.

Accordingly, a need exists for an automated system that can unify the monitoring of various aspects of a patient's well-being to enable healthcare providers to serve a greater number of patients with a minimal invasion of privacy. A system flexible enough to monitor many types of medical devices, even devices not yet contemplated, would be of additional value in the healthcare field.

### SUMMARY

The inventors of the present invention have studied the need for a universal patient monitoring system as discussed above and have developed a relatively low-cost system that is easy to install and to program to monitor events indicated in a large variety of ways. The system assists health care providers in monitoring a greater number of symptoms for a larger number of patients with minimal effect on the patients' privacy.

The invention may be embodied as a system for using a camera to monitor a patient and at least one associated medical device. The system includes a scene segmentation and calibration unit, an analysis unit, and a communication unit. The scene segmentation and calibration unit is operative: (1) to segment a camera's field of view into segments, at least one segment having an image of a patient and at least one segment having an image of a medical device; and (2) to designate activities represented in the segmented images for which to send a notification. The analysis unit is operative: (1) to analyze images captured by the camera according to the field of view segmentation and the activity designation; and (2) to determine when the designated activities have occurred. The communication unit is operative to execute a notification in response to the analysis unit determining that the designated activities have occurred.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates diagrammatically an example of the invention embodied as a system for monitoring a patient and medical devices;

FIGS. 1a-1c provide examples of subject matter that the system of FIG. 1 can monitor; and

FIG. 2 a view of a typical hospital room in which an embodiment of the invention is implemented.

### DETAILED DESCRIPTION

The invention summarized above and defined by the claims below will be better understood by referring to the present detailed description of embodiments of the invention. This description is not intended to limit the scope of claims but instead to provide examples of the invention. Described first is a system embodiment with many variations. Described later is an example implementation of an embodiment of the invention in typical environment therefor.

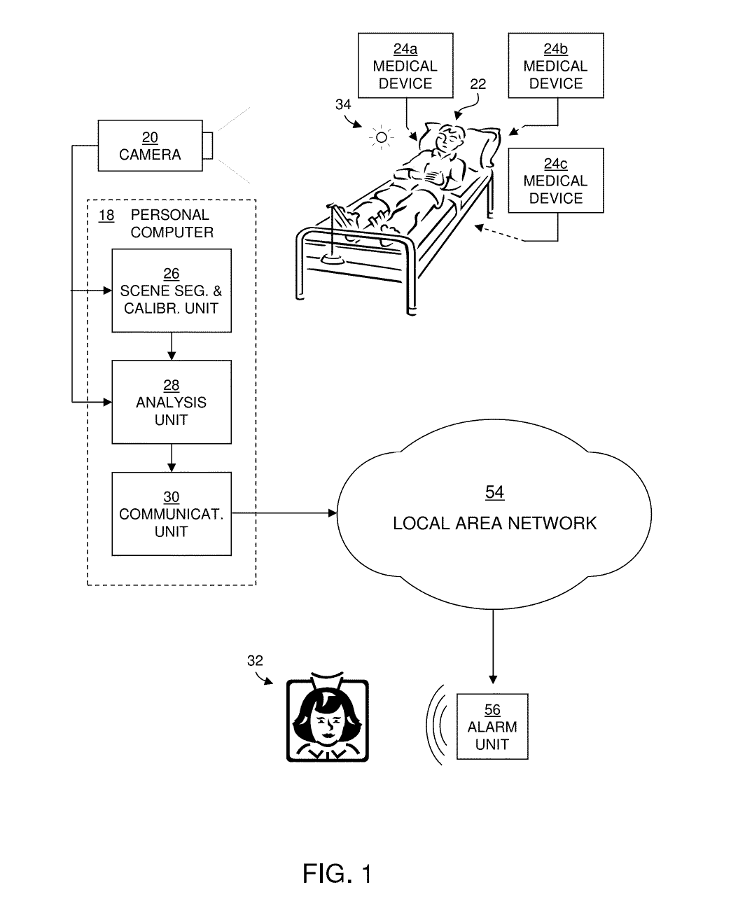

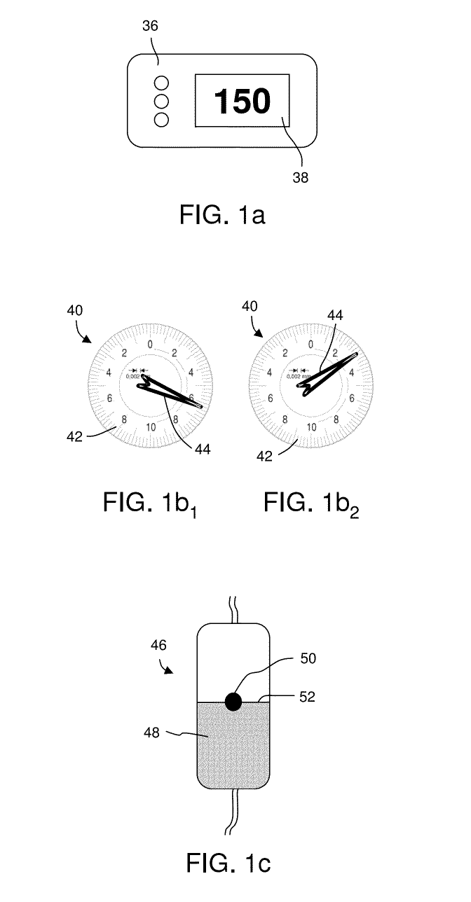

FIG. 1 illustrates one example embodiment of the invention. As shown, this non-limiting embodiment is a system 18 for using a camera 20 to monitor a patient 22 and three associated medical devices 24a, 24b, 24c. Alternate embodiments may monitor a patient and fewer or more medical devices. The camera 20 may employ CCD or CMOS technology, as non-limiting examples.

The medical device 24a is an EKG instrument indicating the heart rate of the patient 22 on a digital display (not shown for clarity), the medical device 24b is an oxygen supply having a gauge that indicates oxygen pressure using an analog display of a rotating needle (not shown for clarity), and the medical device 24c is an intravenous (IV) infusion set delivering liquid substances to the patient 22. (For clarity, the medical devices 24a, 24b, 24c are not illustrated in detail in FIG. 1.) The medical devices 24a, 24b, 24c are non-limiting examples for which the system is suitable. Alternate embodiments may monitor a patient with other types of medical devices.

The system 18 includes a scene segmentation and calibration unit 26, an analysis unit 28, and a communication unit 30, as described in more detail below. In the implementation of FIG. 1, the system 18 is embodied within a personal computer. In other implementations, the system may be embodied within dedicated hardware having a central processing unit (CPU), a memory, and input and output circuitry or alternatively within a Smartphone, as non-limiting examples. In still other implementations, the camera 20 may be built into the system embodying the other elements of the invention.

The scene segmentation and calibration unit 26 receives images captured by the camera 20, which in operation is oriented so that it captures still images and/or a video stream of the patient 22 and of the medical devices 24a, 24b, 24c. The scene segmentation and calibration unit 26 then segments the camera's field of view into segments according to a user's instructions. The user, who may be a nurse 32 or other health care provider or a technician setting up the system for operation, indicates in this embodiment a segmentation of the camera's field of view such at one segment has an image of the patient 22 and three other segments, each having an image of one of the medical devices 24a, 24b, 24c. Another segment may have an image of a flashing light 34 located optionally within the field of view to confirm system operation as discussed in more detail below.

The segmented images provide indications of the well-being of the patient 22 and the proper operation of the medical devices 24a, 24b, 24c and of the monitoring system 18. Regarding the segments displaying the patient 22 himself/herself, images of unhealthy activity include convulsions and abnormal perspiration (manifested by above-average light reflectivity of the patient's skin. The absence of the patient 22 from the field of view segment for more than a preset length of time may also suggest that the patient 22 is in distress. For example, the patient may have left to use the restroom and became unable to return to the bed. Tracking a patient's translational movement while in bed can monitor for occasions when the patient is in danger of falling off the bed, such as whether he is close to the edge of the bed, or if he has fallen off the bed already. Images of digital or analog displays of the medical equipment can indicate unhealthy physical properties, such as an abnormal heart rate. An image of a descending float of an IV infusion set can indicate that the fluid needs to be refilled or that the set is malfunctioning. Regarding the segment of the field of view expected to have the flashing light 34, the absence of a flashing light would suggest that something within the system 18 may be malfunctioning.

The scene segmentation and calibration unit 26 also, according to user instructions, designates the activities represented in the segmented images for which to send a notification, such as an alarm, to the nurse 32 or to a nursing station. As implied above, example designated activities include convulsions, skin-reflectivity changes, the absence of the patient 22, unhealthy physical properties measured by the medical devices 24a, 24b, 24c, and the absence of a flashing light.

The analysis unit 28, like the scene segmentation and calibration unit 26, receives the images captured by the camera 20. The analysis unit 28 analyzes the captured images according to the field of view segmentation and the activity designation of the scene segmentation and calibration unit 26 and determines when the designated activities occur and warrant the sending of a notification. When such an event occurs, the analysis unit 28 produces a signal indicating such.

As discussed above, the medical device 24a is an EKG instrument indicating the heart rate of the patient 22 on a digital display. FIG. 1a provides an illustration of a console 36 providing the digital display 38. Optical character recognition (OCR) software is well-known in the art, as demonstrated for example in U.S. Pat. No. 7,349,588 to Butterworth, incorporated herein by reference in its entirety. The OCR software analyzes the image of the digital display 38 in the segmented view including the console 36 and provides a numerical output. This numerical output is compared to the corresponding value (a limit) set by the user when using the scene segmentation and calibration unit 26 to determine whether a notification of an unhealthy heart rate is warranted.

As also discussed above, the medical device 24b is an oxygen supply having a gauge that indicates oxygen pressure using an analog display of a rotating needle. FIGS. 1b₁ and 1b₂ provide illustrations the analog display 40 having indicia 42 and a rotating needle 44. In FIG. 1b₁, the needle 44 indicates a value of approximately 6 units, and in FIG. 1b₂, the needle 44 indicates a value of approximately 3 units.

As is clear from FIGS. 1b₁ and 1b₂, the measured value indicated by the analog display 40 is represented by the orientation (angle) of the needle 44. Known image processing algorithms determine the orientation of objects. For an example of such algorithms, reference is made to U.S. Pat. No. 4,803,735 issued to Nishida et al., incorporated herein by reference in its entirety. In the present embodiment, the analysis unit 28 determines the measured value from its one-to-one correspondence with the angle of needle 44. The measured is then compared with the corresponding value set by the user indicating low oxygen pressure through the scene segmentation and calibration unit 26 to determine whether a notification of low oxygen pressure is warranted.

As further discussed above, and the medical device 24c is an intravenous (IV) infusion set delivering liquid substances to the patient 22. FIG. 1c provides an illustration of a drip chamber 46 of an IV set, the drip chamber 46 being suspended below a bag of IV solution (for clarity not shown in the present figure). The drip chamber 46 is partially filled with the IV solution 48, and a ball 50 floats on the IV solution 48 and serves as an indication of the height of the surface 52 of the IV solution 48. In the present embodiment, tracking software, known in the art, is implemented to determine when the ball 50 descends beyond a specified limit to indicate a shortage of IV solution 48 and warranting a notification to health care personnel. Reference is made to U.S. Patent Application 2007/0097112, filed by Greig, and U.S. Pat. No. 7,804,506, to Bates et al., incorporated by reference in their entireties, for example of known object tracking software, but the invention is not limited to these examples.

As additionally discussed above, the field of view of the camera 20 may be segmented so that one segment includes images of the flashing light 34. That is, the scene segmentation and calibration unit 26 may be used to segment the field of view into a segment having an image for confirming operation of the system, the image in this example being the flashing light 34. The scene segmentation and calibration unit 26 designates an activity represented in the segment image that indicates a mis-operation of the system. For example, if the system 18 perceives that the light 34 has stopped flashing, it can be inferred that a problem exists, such as a failure in the operation of the camera(s) 20. In some embodiments, upon a perceived malfunction, the analysis unit 28 sends an indication to the alarm unit 56 to notify the nurse 32. Such may be implemented by software, such as that disclosed in U.S. Pat. No. 5,490,075 to Howard et al., herein incorporated by reference. The software detects when the flashing of the light 34 ceases and provides an indication of such within the analysis unit 28. In alternate embodiments, the flashing light may be used to send a message in code, such as Morse code, indicating for example “This is bed No. 234,” and this can detect a human error of a nurse entering a value of “243” in the associated software field.

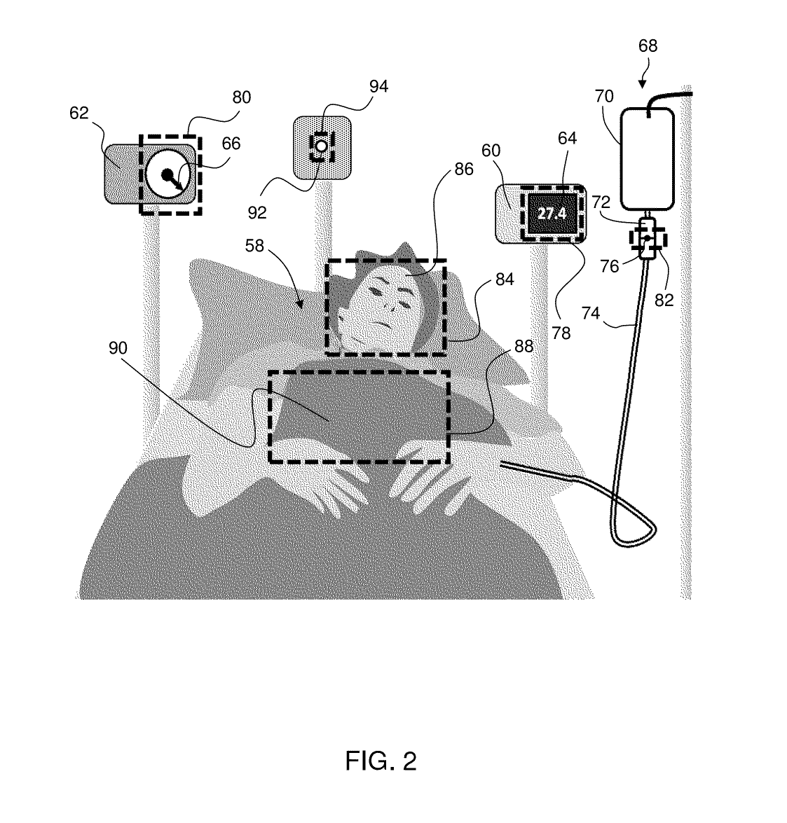

As discussed below with reference to FIG. 2, a field of view may be segmented so that a segment contains an image of a patient's chest, as digital images may be used to analyze a patient's respiration based on the principle that the volume of air that circulates in the lungs is proportional to the movement that the patient makes when breathing. For an example of such analysis, reference is made to U.S. Patent Application 2011/0144517 filed by Cervantes, incorporated herein by reference in its entirety.

As also discussed below with reference to FIG. 2, a field of view may be segmented so that a segment contains an image of a patient's face. The brightness or reflectivity can be detected as an indication of heavy perspiration. For an example of analyzing an image accordingly, reference is made to U.S. Pat. No. 7,502,498 to Wen et al., incorporated herein by reference. The communication unit 30 receives that signal from the analysis unit 28 and in response executes a notification. The notification flows through a local area network (LAN) 54 to an alarm unit 56, which activates in response to receipt of the notification. The alarm unit 56 outputs its response in the form of an audible tone, a flashing light, or an alphanumeric display as non-limiting examples.

In the present embodiment, the personal computer 18 may connect to the LAN 54 via wired or wireless protocol, for example, IEEE 802.11 or Wireless Application Protocol (WAP). In alternate embodiment, another communication medium may be used instead of the LAN 54. Examples of other communication media include direct wiring phone lines and power line communication (PLC). In a still further example, the communication unit 30 may send a notification directly to a cellular telephone of the medical staff member on call.

As discussed above, the system 18 executes a notification when even a single designated activity has occurred, such as the heart rate of the patient 22 reaching an unhealthy level. In alternate embodiments, though, the system 18 may be configured to execute a notification based on multiple activities in combination, each indicative of an aspect of the patient's health. The individual activities can be quantified and used as inputs to a formula, as described for example in Cuthbertson et al., “Can physiological variables and early warning scoring systems allow early recognition of the deteriorating surgical patient?,” Crit Care Med 2007, Vol. 35, No. 2, pp. 402-09, and thus the activities as a whole effect whether to execute a notification.

As noted above, the camera 20 in the present embodiment has a field of view that is capable of capturing images of the patient 22 and images of at least one of the medical devices 24a, 24b, 24c. As also noted, the camera 20 provides the captured images to the scene segmentation and calibration unit 26 and to the analysis unit 28. In alternate embodiments, though, additional cameras may be used, and such may be desirable for scenes that are too big for a single camera to capture by itself. For example, the patient's room may be so small that the medical devices must surround the patient. Multiple single ordinary cameras could be needed to capture all subjects of interest. As another example using multiple cameras, an infrared camera may be added to the system 18 to provide image data in low light conditions. The infrared camera may also be used to provide image data. As with the camera 20, the additional cameras also have fields of view capable of capturing images of the patient and/or images of the medical device, and the additional cameras provide the images it captures to the scene segmentation and calibration unit 26 and to the analysis unit 28. The scene segmentation and calibration unit 26 segments the additional cameras' field of view and designates activities for which to send the notification. The analysis unit 28 analyzes the images captured by the additional cameras and determines when the designated activities have occurred.

In still other embodiments, the system 18 includes a microphone to sense sounds produced by the patient 22 and/or the medical equipment 24a, 24b, 24c. The microphone might be built into the camera 20 or instead be a separate element. Accordingly, the scene segmentation and calibration unit 26 designates specific sounds sensed by the microphone for which to send a notification. The analysis unit 28 analyzes the sounds sensed by the microphone according to the sound designation and determines when the specific designated sounds have been produced. The communication unit 30 executes a notification in response to the analysis unit 28 determining that a designated sound has been produced. Example designated sounds that could cause notifications are those sounds produced by the patient 22, such as coughs, sighs, and repetitive calls “Nurse, nurse” as a sign of distress. Example designated sounds produced by the medical equipment that could cause notifications include alarms and changes in the rhythms of specific machines. IEC 60601-1-8 is an international standard that specifies audible alarms for medical equipment, and such specified alarms can be sensed by the microphone and the sensed audio data processed according to the standard. (The standard also specifies visual alarms for medical equipment, and those also may be sensed by the system and used to trigger a notification.)

The system may also be modified to include a storage unit to store data captured by the camera 20. The storage unit can be used to store data captured by a microphone in systems having a microphone. Storing the history of the monitored activities may be desired for allow the medical staff to review what had happened before, during and after an alarm triggered. In some cases, the symptoms triggering the alarm disappear once the medical staff arrives at the patient's bed, and only careful examination of the events prior to the alarm might reveal what really happened. In other cases, such as when an alarm is false, this information can be used to improve the system's performance.

The system may be configured so that the communication unit 30 executes a notification to indicate the particular designated activity that has occurred. For example, the notification may explicitly indicate to the health care provider 32 that the patient heart rate is exceeding a specified level or that an IV supply has been exhausted.

Alternatively, the system may be configured so that the communication unit 30 executes a notification that does not indicate the particular designated activity that has occurred. The notification might be merely understood to indicate to the health care provider that the patient needs to be visited. Such a configuration may be less expensive, easier to install, and/or require less space at the nursing station.

In one embodiment of the invention, recognized labels (such as the ImageID label developed in Hod Hasharon, Israel) are placed near the source of the information. For example, a star-shaped label can be placed to the right of the digital display 38 of the EKG console (FIG. 1a) to indicate “The digits to the left of this icon indicate heart rate.” As another example, a triangular-shaped label placed under the flashing light 34 (FIG. 1) indicates “The system may be mis-operating when a flashing light is not detected above.) The functionality provided by the recognized labels enables health care provider to set up the system 18 more quickly. The system can also be arranged to so that its components and subjects under observation can be moved in the room without interruption of the monitoring.

The inventors realized that in hospital rooms the medical equipment often moves, whether slightly or a great deal, and that the patient may move in his/her bed. Accordingly, in some embodiments of the invention, the scene segmentation and calibration unit 26 of the system 18 tracks the images of the patient 22 and/or the medical devices 24a, 24b, 24c as they move within a field of view segment. Software for tracking targets is well-known in the art, for example, that used by license plate recognition systems that track vehicle license plates while reading the alpha-numeric characters.

FIG. 2 illustrates a typical scene in a hospital room. A patient 58 lies adjacent an EKG instrument 60 and an oxygen supply 62. The EKG instrument 60 indicates the heart rate of the patient 58 on a digital display 64, and the pressure of the oxygen supply 62 for the oxygen provided to the patient 58 is measured by a pressure gauge with an analog display 66. An IV infusion set 68 includes a suspended bag 70 containing the fluid for infusion to the patient 22, a drip chamber 72 under the bag 70 and a tube 74 leading from the drip chamber 72 to the patient 22. A ball 76 floating on the surface of the liquid in the drip chamber 72 rises and falls as the liquid surface level rises and falls.

A user, such as a health care provider, may set up the system 18 of FIG. 1 by orienting the camera 20 so that its field of view encompasses the patient 58, the EKG instrument 60, the oxygen supply 62, and the IV infusion set 68. Then, using scene segmentation and calibration unit 26 the user segments the scene into a segment 78 including the digital display 64 of the EKG instrument 60, a segment 80 including the analog display 66 of the oxygen supply 62, a segment 82 including the ball 76 floating on the surface of the liquid in the drip chamber 72 of the IV infusion set 68, a segment 84 including the face 86 of the patient 58, and a segment 88 including the chest and abdomen 90 of the patient 58.

Optionally, a light 92 may be positioned within the field of view, and the user can add a segment 94 of the field of view that includes an image of the light 92. Alternatively, an existing light within the field of view, such as a light of one of the medical devices being monitored may be used for segmentation so that the addition of the light 92 would not be necessary.

The user then indicates what would be necessary for the analysis unit 28 to determine that a designated activity has occurred so that a notification would be executed. For example, regarding the medical devices 60, 62, 68, the designated activity associated with the segment 78 could be a patient heart rate above or below a healthy value, the designated activity associated with the segment 80 could be an oxygen pressure below a desired operating pressure for the oxygen supply 62, and the designated activity associated with the segment 82 could be the ball 76 descending below a specified level. Regarding the patient 22, the designated activity associated with the segment 86 could be a particular color indicative of a patient in distress, and the designated activity associated with the segment 90 could be convulsions or spasms associated with coughs. Multiple individual activities related to the appearance of the patient 22 may be monitored and quantified so that in combination they cause a notification to be executed, as discussed above.

Regarding the segment 94 including the light 92, the designated activity associated thereto could be simply the absence of an image of the light, as failure to see the light 92 could very well be the result of a malfunction in the operation of the system 18.

If the user decides to use a microphone, he/she can indicate what audible activity would be such that the analysis unit 28 should determine that a designated activity has occurred for executing a notification. Example audible activity could be coughs, sighs, and repetitive calls “Nurse, nurse” produced by the patient 22 and alarms and sounds indicating changes in the rhythms of specific machines.

Accordingly, an automated system is disclosed that unifies the monitoring of various aspects of a patient's well-being to enable healthcare providers to serve a greater number of patients. Indications of potential health problems (abnormal heart rate, convulsions, et cetera) are providing by unifying the outputs collected from a variety of sources. This system is flexible, as the variety of sources can change and be accommodated accordingly. Even future-developed medical devices with unanticipated protocols can be accommodated by the present system.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A system for using a camera to monitor a patient and at least one associated medical device, the system comprising:
a scene segmentation and calibration unit operative (1) to segment a camera's field of view into segments, at least one segment having an image of a patient and at least one segment having an image of a medical device, and (2) to designate activities represented in the segmented images for which to send a notification;
an analysis unit operative (1) to analyze images captured by the camera according to the field of view segmentation and the activity designation and (2) to determine when the designated activities have occurred; and
a communication unit operative to execute a notification in response to the analysis unit determining that the designated activities have occurred.

2. The system of claim 1 further comprising:
a camera having a field of view capable of (1) capturing images of the patient and images of the medical device and (2) providing the captured images to the scene segmentation and calibration unit and to the analysis unit.

3. The system of claim 2 further comprising:
at least one additional camera having a field of view capable of (1) capturing images of the patient and/or images of the medical device and (2) providing the images it captures to the scene segmentation and calibration unit and to the analysis unit;
wherein the scene segmentation and calibration unit is further operative (1) to segment the at least one additional camera's field of view, and (2) to designate activities for which to send a notification, and the analysis unit is further operative (1) to analyze the images captured by the at least one additional camera and (2) to determine when the designated activities have occurred.

4. The system of claim 2 further comprising:
a microphone operative to sense sounds produced by the patient and/or the medical equipment;
wherein the scene segmentation and calibration unit is operative also to designate specific sounds sensed by the microphone for which to send a notification;
wherein the analysis unit is operative also (1) to analyze the sounds sensed by the microphone according to the sound designation and (2) to determine when the specific designated sounds have been produced; and
wherein the communication unit is operative also to execute a notification in response to the analysis unit determining that a designated sound has been produced.

5. The system of claim 1 further comprising:
a storage unit operative to store data captured by the camera.

6. The system of claim 4 further comprising:
a storage unit operative to store data captured by the camera and the microphone.

7. The system of claim 1, wherein the scene segmentation and calibration unit is operative also (1) to segment the field of view into a segment having an image for confirming operation of the system and (2) to designate an activity represented in the segment images that indicates mis-operation of the system.

8. The system of claim 1, wherein at least one designated activity is a specified change in the patient's visual appearance.

9. The system of claim 1, wherein at least one designated activity is a specified change in the patient's presence.

10. The system of claim 1, wherein at least one designated activity is a specified amount or range of a property measured by the medical device.

11. The system of claim 1, wherein at least one designated activity indicates a change in the operation of the medical device.

12. The system of claim 4, wherein at least one designated sound is produced by the patient.

13. The system of claim 4, wherein at least one designated sound is produced by the medical equipment.

14. The system of claim 1, wherein the notification executed by the communication unit indicates the designated activity that occurred.

15. The system of claim 1, wherein the notification executed by the communication unit does not indicate the designated activity that occurred.

16. The system of claim 1, wherein the scene segmentation and calibration unit is further operative to track an image of a patient or medical device as the patient or medical device moves within a field of view segment.

17. The system of claim 1 further comprising:
an alarm unit operative to activate in response to a notification executed by the communication unit response.

18. The system of claim 1, wherein a notification is executed based on multiple designated activities in combination, each activity being indicative of an aspect of the patient's health.

19. The system of claim 1, wherein the system is operative to monitor the patient and at least two medical devices.

20. The system of claim 1, wherein one of the field of view segments has an image of one of the at least two medical devices and another field of view segments has an image of another of the at least two medical devices.

21. The system of claim 1, wherein a segment has an image of the flashing light that sends a message in code.
